(19) United States
(12) Patent Application Publication
(10) Pub. No.: US 2025/0245945 A1
(43) Pub. Date: Jul. 31, 2025

(54) EXTENDED REALITY-BASED VISUALIZATION FOR INFORMATION TECHNOLOGY PLANNING AND INSTALLATION

(71) Applicant: Synopsys, Inc., Sunnyvale, CA (US)

(72) Inventors: Richard Y. Kim, Sunnyvale, CA (US); Robert Paul Parris, Cheyenne, WY (US); Robert James Collier, Cambridge (GB)

(21) Appl. No.: 18/429,377

(22) Filed: Jan. 31, 2024

(51) Int. Cl. G06T 19/20

(52) U.S. Cl. CPC G06T 19/20

(57) ABSTRACT

In one example, a method includes outputting (302) a virtual representation of a physical component of prototyping system, receiving (304) an input indicating an installation status of the physical component, determining (306) that the installation status of the physical component does not match the virtual representation of the physical component, and outputting (308), by a processing system, an indicator to show where the installation status fails to match the virtual representation.

### TECHNICAL FIELD

The present disclosure relates generally to integrated circuits, and relates more particularly to extended-reality based visualization for information technology planning and installation.

### BACKGROUND

A data center is a large group of networked computer servers, typically used by an enterprise for the remote storage, processing, and/or distribution of large amounts of data. The main components of a data center are the information technology (IT) hardware (i.e., the servers and related infrastructure) and the physical space used to house the IT hardware.

In addition to the servers, the hardware may include storage systems (e.g., disk arrays), networking equipment (e.g., switches, routers, firewalls, etc.), backup power supplies, and cables and racks used to organize and connect the hardware. Miles worth of cables may be used to connect all of the hardware into a unified, functioning system.

### SUMMARY

In one example, a method includes outputting a virtual representation of a physical component of a prototyping system, receiving an input indicating an installation status of the physical component, determining that the installation status of the physical component does not match the virtual representation of the physical component, and outputting, by a processing system, an indicator to show where the installation status fails to match the virtual representation.

In another example, a non-transitory computer readable medium includes stored instructions which, when executed by a processor, cause the processor to output, to a display, a virtual representation of a physical component of a data center to be installed, receive an input indicating an installation status of the physical component, determine that the installation status of the physical component does not match the virtual representation of the physical component, and output, to the display, an indicator to show where the installation status fails to match the virtual representation.

In another example, a method includes obtaining a set of configuration parameters for a data center, rendering a virtual representation of the data center, based on the set of configuration parameters, outputting the virtual representation of the data center to a display, and saving the virtual representation of the data center in response to receiving a signal to finalize the virtual representation.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 illustrates an example method for supporting planning of a data center using extended-reality based visualization, according to the present disclosure.

FIG. 2 illustrates an example virtual representation of a portion of a data center including two racks.

FIG. 3 illustrates an example method for guiding an installation of a data center using extended-reality based visualization, according to the present disclosure.

FIG. 4 illustrates an example virtual representation of a hardware module of a data center.

FIG. 5 depicts a diagram of an example computer system in which embodiments of the present disclosure may operate.

### DETAILED DESCRIPTION

Aspects of the present disclosure relate to extended-reality based visualization for information technology planning and installation. As discussed above, the main components of a data center are the IT hardware and the physical space used to house the IT hardware. The hardware may include servers, storage systems, networking equipment, backup power supplies, and cables and racks used to organize and connect the hardware. Miles worth of cables may be used to connect all of the hardware into a unified, functioning system.

The design and installation of data centers are often largely manual and iterative processes, and can be prone to errors even for experienced users. For instance, although prototyping tools exist to help visualize different architectural choices when building a data center, the input files that are used by the prototyping tools as the bases for the visualizations must often be manually generated. If the user creating an input file for prototyping is unaware of or overlooks an inherent constraint in the hardware, this may result in technical errors in the input file that are carried over into the prototyping. Such errors may not be detected until much further along in the design process, resulting in much of the design process having to be repeated.

On the installation side, the sheer number of cable connections between hardware components in even a relatively small data center can make installation a complex and error-prone task. Often, an error in cabling may not be detected right away. Even once detected, the incorrectly connected cable(s) may be difficult to identify, again due to the large number of cables used. This can prolong the installation process and any hardware downtime associated therewith.

Examples of the present disclosure utilize extended reality-based techniques to generate a model of a data center which may be used for visualization purposes during design and installation of the data center. In one example, the model is a virtual representation (e.g., a digital twin) of the data center and can be used to simulate the effects of different hardware configurations and interactions within the data center, thereby allowing for the validity of different architectural choices to be confirmed prior to installation. In particular, the use of the virtual representation allows users to identify cable faults and mismatches, to visualize cabling scenarios and track connections, to conduct diagnostic tests and analyze outcomes, to understand data center layouts and cable length needs, to filter and track installed cables in large data centers, and to experiment with extension board placements and heights, all without requiring access to the physical data center.

During installation, the model may be used to iteratively and systematically guide the placement of hardware and the routing of cables, and to continuously validate the placement and routing that have been completed. Alerts for any detected errors in placement or routing may be generated at each step of the installation process, so that the detected errors can be corrected before the installation process proceeds.

Technical advantages of the present disclosure include, but are not limited to, the ability to minimize errors in data center design and installation by allowing users to visualize and interact with a virtual representation of the data center and the data center's components (such as racks, hardware modules, cables, and the like). By detecting errors and thereby allowing the causes of those errors to be identified and corrected earlier in the design and installation processes, the time required to design and install a properly functioning data center to specification can be reduced by as much as several days.

Moreover, the functioning of the data center is improved by ensuring that a proposed layout, including hardware selection, placement, and interconnections, can be physically deployed within a given space and can function in a manner intended by a data center planner.

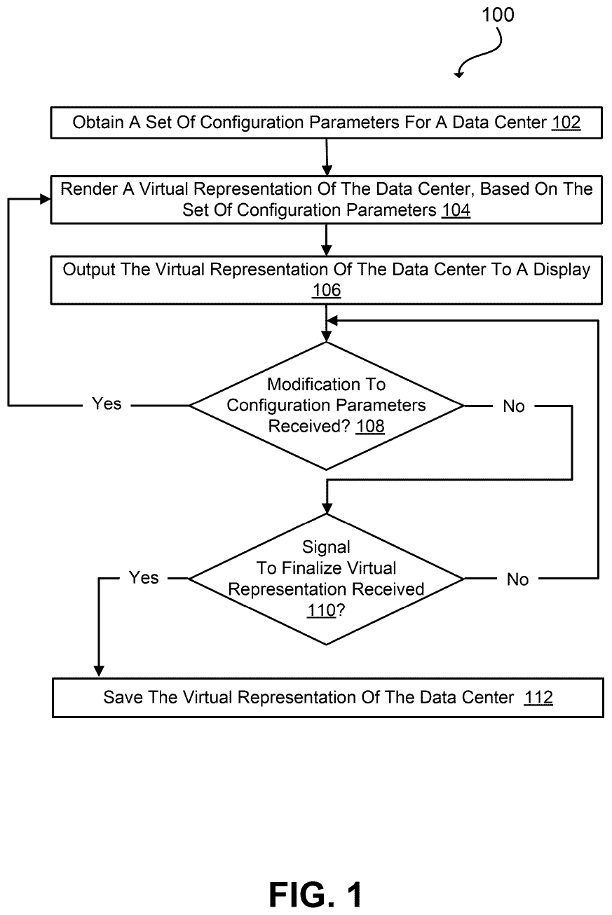

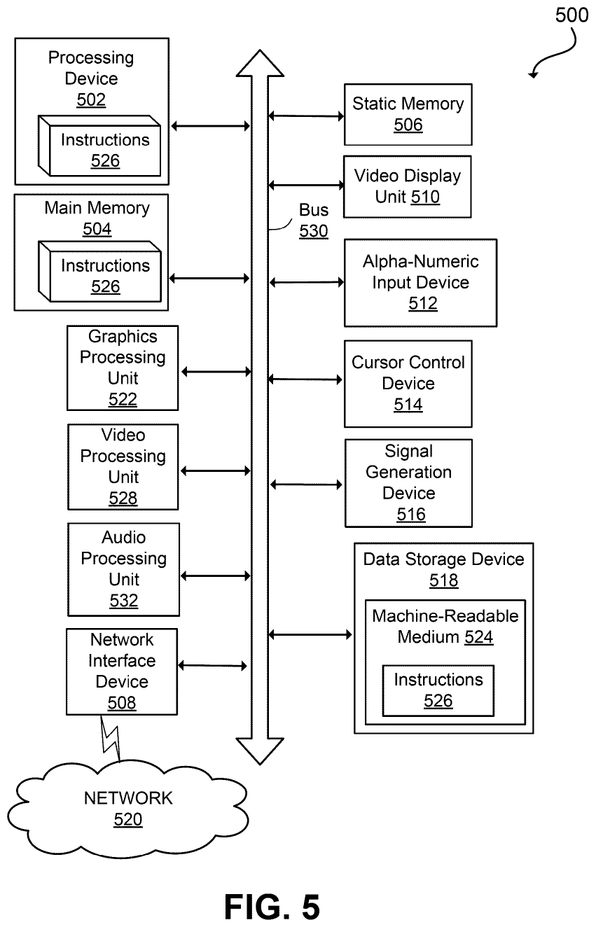

To further aid in understanding the present disclosure, FIG. 1 illustrates an example method 100 for supporting the planning of a data center using extended-reality based visualization, according to the present disclosure. In one example, the method 100 may be performed by one or more components of an application server or a computer system, such as the computer system 500 illustrated in FIG. 5. For the sake of example, the method 100 is described as being performed by a processing system.

In step 102, the processing device may obtain a set of configuration parameters for a data center. In one example, the data center may comprise part of a prototyping system, such as a prototyping system used develop and validate systems on chip (SOCs) and components thereof. In one example, the set of configuration parameters may include at least one of: physical dimensions of the data center, a layout of the data center (e.g., locations of walls, doors, windows, and other permanent structures), a number of racks in the data center, a number of hardware modules in the data center, types of the hardware modules, locations of the hardware modules in the data center, a number of cables connecting the hardware modules, types of the cables, locations of the cables, lengths of the cables, and/or other parameters.

In one example, the set of configuration parameters may be obtained in the form of an input file that is imported from another application, device, or the like. For instance, the method 100 may include execution of a first software program by the processing system, while a second, separate software program executed by the processing system (or by another device) may be used to generate an initial configuration for the data center, including the set of configuration parameters, as an input file. The processing system may parse the input file for the set of configuration parameters.

In another example, the set of configuration parameters may be obtained from a user interacting with a graphical user interface (GUI) that is output by the processing system to a display. The GUI may allow the user to define a layout of the data center, and may further allow the user to insert pre-defined templates for racks, hardware modules, cables, and the like into the layout. The user may use the templates for the racks, hardware modules, cables, and the like as basic building blocks that can be combined to define more complex data center configurations. In some examples, the processing system may suggest one or more proposed configurations based on user-specified requirements such as the number of hardware modules and physical data center layout.

In step 104, the processing system may render a virtual representation of the data center, based on the set of configuration parameters. As discussed above, the virtual representation may include a digital twin of the data center, e.g., an extended reality-based model that emulates the physical parameters, behaviors, and interactions of the components (e.g., racks, hardware modules, cables, etc.) of the data center.

In one example, rendering the virtual representation may include rendering virtual representations of a plurality of hardware modules and a plurality of cables connecting the plurality of hardware modules. The hardware modules may include field programmable gate arrays (FPGAs), extension boards, and other hardware. The virtual representations of the hardware modules may include scale models to facilitate accurate visualization of the physical hardware modules. The scale models may include ports and other connection points and may be configured to behave in a manner similar to the manner in which the physical hardware models behave (e.g., in terms of power consumption, computing capabilities, interaction with other hardware modules, and the like).

In one example, rendering the plurality of hardware modules may include determining valid placements for one or more extension boards on the top surface of an FPGA. Extension boards provide a modular solution for expanding the capabilities of an FPGA, but valid placements for the extension boards on an FPGA may be limited due to the presence of other extension boards, to super logic region (SLR) boundaries on connectors of the FPGA which cannot be crossed, and other constraints. In one example, rendering of an FPGA may include visually indicating locations on the FPGA where extension boards cannot be placed.

In one example, rendering the plurality of hardware modules may include calculating an amount of vertical space between two FPGAs that is needed to provide clearance for one or more extension boards on one of the FPGAs. For instance, if a first FPGA includes one or more extension boards that extend vertically upward from the top surface of the first FPGA, then a second FPGA placed above the first FPGA in the rack would need to be placed high enough above the first FPGA to avoid physical contact with the extension board(s). Cables attached to endpoints on the top surface of the first FPGA, including the extension board(s), may also require some amount of physical clearance.

In one example, rendering the plurality of cables may include calculating a minimum length for each cable of the plurality of cables. Cables are an integral component of a data center that allow for flexible connectivity between multiple hardware modules, and cable length should be optimized to avoid unnecessary cost and latency. For instance, a cable should be long enough to securely connect two endpoints, but not so long that transfer of data between the endpoints is unduly delayed. Because examples of the present disclosure utilize accurate scale models of the hardware modules in the virtual representation of the data center, a minimum distance between endpoints on a hardware module (or on two hardware modules) can be accurately calculated. In one example, calculating the minimum distance may also account for any physical limitations of the cables to be used (e.g., bend radius, predefined maximum length, etc.), any user-defined tolerances, and any physical limitations of the rack systems in which the cables are to be deployed (e.g., U positions of the hardware modules in the racks, horizontal spacing between racks, whether cables are permitted to pass through particular sides of the racks, etc.).

In step 106, the processing system may output the virtual representation of the data center to a display. In one example, the display may allow a user to interact with the virtual representation. Interaction with the virtual representation may include viewing the virtual representation (or components of the virtual representations, such as models of racks, hardware modules, and/or cables) from any angle (e.g., in 360 degrees), moving components of the virtual representation to new locations, adding new components to the virtual representation, deleting existing components from the virtual representation, or the like.

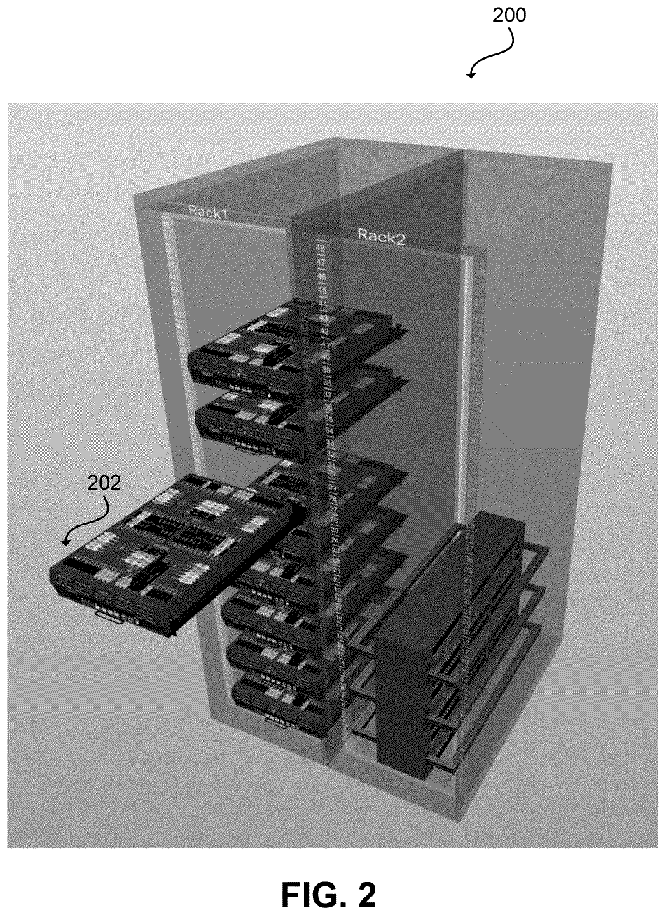

FIG. 2, for instance, illustrates an example virtual representation 200 of a portion of a data center including two racks (labeled Rack 1 and Rack 2). One of the racks (i.e., Rack 1) houses a plurality of hardware modules (e.g., FPGAs). The virtual representations of the racks can be viewed with the virtual representations of the hardware modules installed. Additionally, the virtual representations of any of the hardware modules may be “removed” from the virtual representations of the rack for viewing in further detail. For instance, FIG. 2 illustrates a virtual representation of a hardware module 202 being removed from Rack 1. Removing the virtual representation of the hardware module 202 from Rack 1 allows the details of virtual representation of the hardware module 202 to be viewed, including the connectors, the cabling that may connect some of the connectors, and any extension boards that may be installed on the hardware module.

In a further example, interaction with the virtual representation may include viewing information about components of the virtual representation. For instance, a user may be able to select (e.g., by clicking on, moving a pointer over, or touching on a touch screen display) a cable and view a value that indicates a minimum length for the cable, an actual length of the cable as determined by the virtual representation, a type of the cable, endpoints of the cable (i.e., what the ends of the cable connect to), or other information about the cable. Similarly, a user may be able to select a hardware module and view information about the hardware module such as FPGA type, FPGA make and model, FPGA manufacturer, other hardware modules to which the hardware module is connected, or the like. A user may be able to select a rack and view the location of the rack, the number of hardware modules housed within the rack, and/or other information about the rack.

In step 108, the processing system may determine whether a modification to the configuration parameters has been received. For instance, as discussed above, a user may interact with the virtual representation in order to move components of the virtual representation to new locations, add new components to the virtual representation, delete existing components from the virtual representation, or make other modifications to the virtual representation. As an example, once the user can visualize how the data center would look and operate, the user may choose to move a rack, add an extension card to an FPGA, increase the spacing between FPGAs housed within the same rack, or the like. Such modifications may be indicated through interaction with the virtual representation and may result in modifications to the configuration parameters that were originally obtained in step 102. For instance, the user may drag and drop hardware components, cables, or the like into, out of, or to different locations within the virtual representation.

If the processing system concludes in step 108 that a modification to the set of configuration parameters has been received, then the method 100 may return to step 104, and the processing system may re-render the virtual representation to include the modification(s) received. The method 100 may then proceed as described above. If, however, the processing system concludes in step 108 that a modification to the set of configuration parameters has not been received, then the method 100 may proceed to step 110.

In step 110, the processing system may determine whether a signal to finalize the virtual representation has been received. For instance, the user may select (e.g., by clicking on, tapping, or otherwise interacting with) a button or other components of the GUI that may indicate that the design of the data center, as currently depicted in the virtual representation, is accepted. The user may select the button or other components once the user has determined that no further modifications to the virtual representation are needed or desired.

If the processing system concludes in step 110 that a signal to finalize the virtual representation has not been received, then the method 100 may return to step 108, and the processing system may wait for a signal indicating a modification to or a finalization of the virtual representation. If, however, the processing system concludes in step 110 that a signal to finalize the virtual representation has been received, then the method 100 may proceed to step 112.

In step 112, the processing system may save the virtual representation of the data center. In one example, the virtual representation may be saved to a database that stores virtual representations of various different data centers. This database, or at least the virtual representation stored therein, may be accessible by a team that is subsequently dispatched to install the data center (where the members of the team that is dispatched to install the data center may not be involved in the design and configuration of the data center). The virtual representation may be used by the team to guide installation of the data center, as discussed in further detail in connection with FIG. 2.

In a further example, a bill of materials (BOM) or similar spreadsheet showing the inventory of racks, hardware modules, extension boards, cables, and the like included in the data center may be extracted from the virtual representation. The BOM may be used to help track the installation of the data center. For instance, in one example, the BOM may be printed using a label maker, thereby allowing a label to be created for each physical component of the data center. The labels may be used to label the physical components prior to installation, which may help the installer to quickly locate the components required at each step of the installation process.

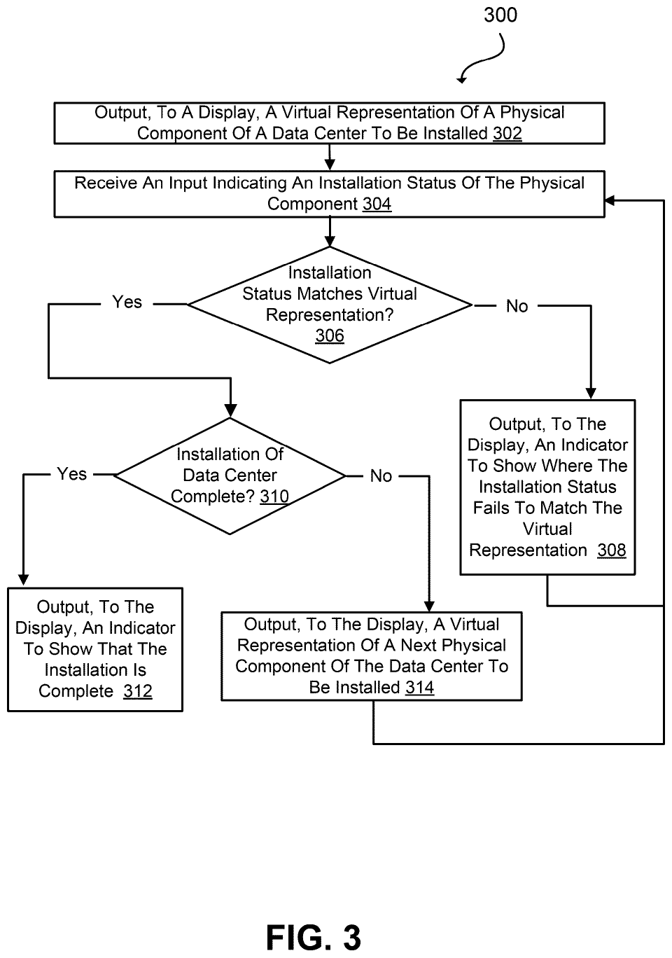

FIG. 3 illustrates an example method 300 for guiding an installation of a data center using extended-reality based visualization, according to the present disclosure. In one example, the method 300 may be performed by one or more components of an application server or a computer system, such as the computer system 500 illustrated in FIG. 5. For the sake of example, the method 300 is described as being performed by a processing system.

In one example, the method 300 may define an order in which the various physical components of the data center (e.g., racks, hardware modules, cables, etc.) are to be installed and configured. For instance, the method 300 may first guide a user through installation of the racks of the data center. Once the racks are installed, installation may proceed with the hardware modules housed in the racks. In one example, installation may proceed one hardware module at a time, and move on to a next hardware module only once installation and configuration of a current hardware module has been validated (alternatively, validation of hardware modules may be delayed until all hardware modules are installed). Installation and configuration of a hardware module may include installation of any extension boards and intra-module cabling connected to the hardware module (i.e., installation of cables whose endpoints all connect to the hardware module being installed).

Once all of the hardware modules (and their extension boards and intra-module cabling) are validated to be installed and configured correctly, installation may proceed to the installation of inter-module cabling (i.e., installation of cabling whose endpoints connect to two different hardware modules). In one example, inter-module cabling may proceed in a bottom-to-top manner, i.e., beginning with inter-module cabling of the hardware modules housed on the lowest shelves of a rack and subsequently proceeding to inter-module cabling of the hardware modules housed on the higher shelves of the rack. Working from the bottom to the top instead of from the top to the bottom may limit potential obstructions, such as hanging cables, blocking access to connectors on the hardware modules and the like.

The method 300 may begin in step 302. In step 302, the processing system may output, to a display, a virtual representation of a physical component of a data center to be installed.

As discussed above, a virtual representation of the data center may be constructed. The virtual representation of the data center may include a digital twin of the data center, e.g., an extended reality-based model that emulates the physical parameters, behaviors, and interactions of the physical components of the data center. The virtual representation of the data center may be constructed according to the method 100, described above.

The virtual representation of the physical component may similarly include a digital twin of the physical component, where the digital twin of the physical component makes up a portion of the digital twin of the data center. In one example, the physical component may include a rack, a hardware module (e.g., an FPGA, an extension board, or the like), or a cable. In one example, the processing system may display the virtual representation of the physical component in response to a request from a user to filter the data being output to the display so that only the virtual representation of the physical component that is currently being installed is viewable (and all other portions of the virtual representation of the data center are temporarily not viewable). Where the physical component is a hardware module, the virtual representation of the physical component may depict not just the hardware module, but also any intra-module cables connected to the hardware module that are to be installed at the same time that the hardware module is to be installed.

In one example, the display may include a GUI that allows the user to view the virtual representation of the physical component from various angles, to interact with the virtual representation of the physical component, and to filter the portions of the virtual representation of the physical component that are output to the display. Filtering may allow the user to view only specific lengths or types of cable, to review an expected appearance of the physical component, or to review an actual (observed or discovered) appearance of the physical component determined from a scan of the physical component.

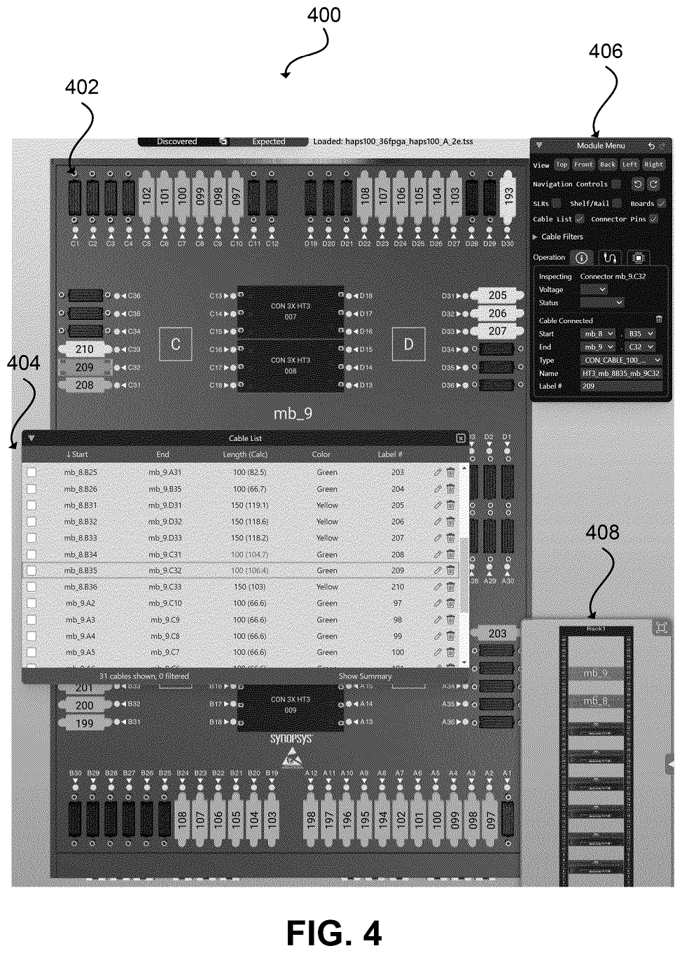

FIG. 4, for instance, illustrates an example virtual representation of a hardware module 400 (e.g., an FPGA) of a data center. More particularly, the view of the virtual representation shown in FIG. 4 shows the top surface of the hardware module 400. A menu 406 of the GUI may be used to toggle between different views of the hardware module 400, such as top, front, back, left, right, and the like. An inset 408 may show a location of the hardware module 400 within a virtual representation of a rack of the data center. For instance, the inset 408 may identify a number or other identifiers of the rack and may illustrate which shelf of the rack houses the hardware module 400.

As illustrated, the top surface of the hardware module 400 includes a plurality of connectors, one of which is labeled (for ease of illustration) as 402. Alphanumeric identifiers (e.g., A1-A36, B1-B36, C1-C36, D1-D36) printed on the top surface of the hardware module 400 may uniquely identify each connector 402. Different connectors 402 may be shaded or filled in with different colors to indicate whether the connectors 402 are attached to a cable, whether the cables that are supposed to be attached to the connectors 402 have been installed, and/or what types or lengths of cable are connected to the connectors 402.

Information about cable connections may also be displayed in the form of a list 404. In one example, the list 404 may define, for each cable that is connected to the hardware module 400, the alphanumeric identifier of the starting connector 402 to which the cable is connected, the alphanumeric identifier of the ending connector 402 to which the cable is connected, the length of the cable (e.g., in inches or another unit of measure), a displayed color of the cable in the virtual representation of the hardware module 400 (where the displayed color may indicate the installation status of the cable as installed, not installed, incorrectly installed, or the like), a unique numeric label assigned to the cable (which may be used to label the connectors 402 to which the cable is connected), and/or other information.

Referring back to FIG. 3, in step 304, the processing system may receive an input indicating an installation status of the physical component. In one example, the input may include a signal initiated by the user indicating that the physical component has been installed. In one example, where the physical component is a hardware module that includes intra-module cabling, the user may initiate a signal by clicking on a portion of the virtual representation that depicts an intra-module cable that the user has installed (e.g., effectively “marking” the intra-module cable as having been installed). In response, the processing system may remove the “marked” intra-module cable from the virtual representation of the physical component or may otherwise change the appearance of the marked intra-module cable (e.g., change the color from red to green, gray out, etc.) to indicate that the marked intra-module cable has been installed.

In a further example, the input may include a value transmitted by the physical component or by another device in the vicinity of the physical component (e.g., a sensor such as a camera, a current transformer, or the like). As an example, the value may include a measure of an amount of electrical power being consumed by the physical component or a strength of a network signal measured by the physical component (which may indicate that the physical component is installed in such a way that the physical component is able to be powered on and to connect to a network). In another example, the value may include a nonce or an arbitrary value transmitted via an intra-module cable (which may indicate that data is capable of being transmitted between the endpoints of the intra-module cable).

In step 306, the processing system may determine whether the installation status of the physical component matches the virtual representation of the physical component. In other words, the processing system may use the virtual representation to validate the installation of the physical component. As discussed above, in one example, the user may send a signal to the processing system each time a physical component or a part of a physical component (e.g., an intra-module cable connected to a hardware module) is installed. Once the processing system has received such a signal for every part of the physical component currently being installed, the installation of the physical component may be assumed by the processing system to match the virtual representation.

In one example, the validation of the installation may involve comparing observed values received from the physical component or another device in the vicinity of the physical component (e.g., values that are contained in the input received in step 304) to expected values (e.g., values that are expected to be observed when the physical component is properly installed). If the observed values match the expected values, then the installation status may be determined to match the virtual representation (e.g., to be valid). If the observed values do not match the expected values, then the installation status may be determined to not match the virtual representation (e.g., to be invalid).

For instance, for a rack, the virtual representation may indicate the location of the rack in the data center, positions of components of the rack (e.g., shelves, rails, etc.), and other characteristics of the rack. For instance, some hardware modules may require a fixed depth. A rack configured to house such hardware modules must be installed so that the front and rear vertical rails of the rack are positioned to provide the fixed depth, which may be indicated in the virtual representation. In this case, the input received in step 304 may include images of the rack, where the images may depict the location of the rack within the data center or relative to other racks, the number of shelves included in the rack, and/or other characteristics of the rack. Alternatively, the input received in step 304 may include measurements of the rack's depth, height, or other physical dimensions provided by the user. Validation of installation may involve confirming, based on these inputs, that the rails of the rack are installed at the expected depth, that the rack includes the expected number of shelves spaced an expected distance apart from each other, and the like.

For an FPGA, the virtual representation may indicate a specific rack unit (RU) position or rack profile of the FPGA (e.g., the rack and shelf on which the FPGA resides). The virtual representation may further depict the locations and lengths of any intra-module cabling of the FPGA, the type and location of any extension boards connected to the FPGA, and the like. In this case, the input received in step 304 may include images of the FPGA, where the images may depict the location of the FPGA within a rack of the data center, the locations of intra-module cabling connected to the FPGA, the locations of extension boards connected to the FPGA, and/or other characteristics of the FPGA. Alternatively, as discussed above, the input received in step 304 may include signals initiated by the user confirming installation. Validation of installation may involve confirming, based on these inputs, that the FPGA is installed in the expected RU position, that the FPGA includes the expected number of extension boards connected in the expected locations, that endpoints on the FPGA are connected to expected other endpoints on the FPGA, and the like.

For a plurality of connected FPGAs, a virtual representation may indicate the connectors on two different FPGAs that are connected to each other via a cable. In this case, the input received in step 304 may include images of the FPGAs, where the images may depict the locations of the locations of inter-module cabling connected to the FPGAs and/or other characteristics of the FPGAs. Alternatively, as discussed above, the input received in step 304 may include signals initiated by the user confirming installation of the inter-module cables. Validation of installation may involve confirming, based on these inputs, that the connectors on two FPGAs are connected to each other by a cable of an expected or specified length, and the like.

If the processing system concludes in step 306 that the physical component does not match the virtual representation of the physical component, then the method 300 may proceed to step 308. In step 308, the processing system may output, to the display, an indicator to show where the installation status fails to match the virtual representation.

For instance, in one example, any portions of the virtual representation that do not match their counterparts in the physical component may be highlighted in a different color, or otherwise altered in the virtual representation to visually differ from the rest of the virtual representation. This may allow a user to quickly and easily identify the installation errors and to correct the errors.

The method 300 may then return to step 304 and may proceed as described above to receive subsequent inputs indicating an updated installation status of the physical component and to determine whether the updated installation status matches the virtual representation.

If, however, the processing system concludes in step 306 that the physical component matches the virtual representation of the physical component, then the method 300 may proceed to step 310. In step 310, the processing system may determine whether the installation of the data center is complete.

As discussed above, a data center may include many physical components, including a plurality of racks, each of which may house a plurality of hardware modules. Moreover, a plurality of cables may connect components of a hardware module, connect hardware modules to other hardware modules, and the like. The method 300 may guide a user through installation of these various physical components one by one; thus, once proper installation of one physical component is confirmed, the processing system may identify the next physical component to be installed. Steps 304-310 may therefore repeat until no physical components are left to install (i.e., the installation status of every physical component matches the virtual representation of that physical component, indicating that the installation of the data center is complete).

If the processing system concludes in step 310 that the processing system is complete, then the method 300 may proceed to step 312. In step 312, the processing system may output, to the display, an indicator to show that the installation is complete.

In one example, the indicator may include a text-based message stating that installation is complete. In another example, the indicator may include a graphic of a completed installation checklist or list of tasks. In another example, the indicator may include some visual modification to the virtual representation of the data center that indicates that the installation of the data center is complete. The indicator may signal to the user that the data center is ready for full system diagnostics to be performed. The processing system may share information with the system used to perform the diagnostics. For instance, the processing system may share the virtual representation of the data center (which illustrates the expected appearance of the data center) with the diagnostic system, and the diagnostic system may share any results of the diagnostics (which may indicate a need for modification of the current state of the data center) with the processing system. For instance, the processing system may activate an LED indicator on a physical component when diagnostics indicate that the physical component does not appear to be functioning as expected.

If, however, the processing system concludes in step 310 that the processing system is not complete, then the method 300 may proceed to step 314. In step 314, the processing system may output, to the display, a virtual representation of a next physical component of the data center to be installed.

As discussed above, the various physical components may be installed in a defined order (e.g., racks one by one, followed by hardware modules one by one, followed by cables one by one). Based on this order, the processing system may determine which physical component is the next physical component that should be installed.

The method 300 may then return to step 304 and may proceed as described above to receive subsequent inputs indicating an installation status of the next physical component and to determine whether the installation status of the next physical component matches the virtual representation of the next physical component.

In further examples, the virtual representations used to design and install a data center may be used to facilitate maintenance of the data center and the physical components of the data center. For instance, the data center may be periodically scanned for failures, malfunctions, and the like. The virtual representation of the data center may be updated to indicate the sources of the failure, malfunctions, or the like to maintenance personnel and to provide suggested remedial actions.

FIG. 5 illustrates an example machine of a computer system 500 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM), a static memory 506 (e.g., flash memory, static random access memory (SRAM), etc.), and a data storage device 518, which communicate with each other via a bus 530.

Processing device 502 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 may be configured to execute instructions 526 for performing the operations and steps described herein.

The computer system 500 may further include a network interface device 508 to communicate over the network 520. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), a graphics processing unit 522, a signal generation device 516 (e.g., a speaker), graphics processing unit 522, video processing unit 528, and audio processing unit 532.

The data storage device 518 may include a machine-readable storage medium 524 (also known as a non-transitory computer-readable medium) on which is stored one or more sets of instructions 526 or software embodying any one or more of the methodologies or functions described herein. The instructions 526 may also reside, completely or at least partially, within the main memory 504 and/or within the processing device 502 during execution thereof by the computer system 500, the main memory 504 and the processing device 502 also constituting machine-readable storage media.

In some implementations, the instructions 526 include instructions to implement functionality corresponding to the present disclosure. While the machine-readable storage medium 524 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 502 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method comprising:
outputting a virtual representation of a physical component of a prototyping system;
receiving an input indicating an installation status of the physical component;
determining that the installation status of the physical component does not match the virtual representation of the physical component; and
outputting, by a processing device, an indicator to show where the installation status fails to match the virtual representation.

2. The method of claim 1, wherein the physical component is at least one of: a rack, a field programmable gate array, an extension board, or a cable.

3. The method of claim 2, wherein the physical component is one of a plurality of physical components of the prototyping system, and wherein the plurality of physical components is to be installed in an order in which a rack is installed first, at least one hardware module is installed in the rack after the rack is installed, an intra-module cabling is installed on the at least one hardware module after the at least one hardware module is installed, and an inter-module cabling between the at least one hardware module and another hardware module is installed after the intra-module cabling is installed.

4. The method of claim 1, further comprising:
receiving, after the outputting, a subsequent input indicating an updated installation status of the physical component.

5. The method of claim 4, further comprising:
determining that the updated installation status of the physical component matches the virtual representation of the physical component;
determining, after determining that the updated installation status of the physical component matches the virtual representation of the physical component, that installation of the prototyping system is incomplete; and
outputting, to the display, a virtual representation of a next physical component of the prototyping system to be installed.

6. The method of claim 5, further comprising:
receiving, after the outputting the virtual representation of the next physical component of the prototyping system to be installed, an input indicating an installation status of the next physical component;
determining that the installation status of the next physical component matches the virtual representation of the next physical component;
determining, after determining that the installation status of the next physical component matches the virtual representation of the next physical component, that installation of the prototyping system is complete; and
outputting, to the display, an indicator to show that the installation of the prototyping system is complete.

7. The method of claim 1, wherein the input comprises a signal initiated by a user indicating that the physical component has been installed.

8. The method of claim 7, further comprising:
modifying an appearance of the virtual representation of the physical component on the display to show that the physical component has been installed.

9. The method of claim 1, wherein the input comprises a value transmitted by the physical component.

10. The method of claim 9, wherein the indicator comprises a modification to an appearance of the virtual representation of the physical component on the display.

11. The method of claim 1, wherein the virtual representation of the physical component comprises a digital twin of the physical component.

12. A non-transitory computer readable medium comprising stored instructions which, when executed by a processor, cause the processor to:
output, to a display, a virtual representation of a physical component of a data center to be installed;
receive an input indicating an installation status of the physical component;
determine that the installation status of the physical component does not match the virtual representation of the physical component; and
output, to the display, an indicator to show where the installation status fails to match the virtual representation.

13. A method comprising:
obtaining a set of configuration parameters for a data center;
rendering a virtual representation of the data center, based on the set of configuration parameters;
outputting the virtual representation of the data center to a display; and
saving the virtual representation of the data center in response to receiving a signal to finalize the virtual representation.

14. The method of claim 13, further comprising:
receiving a modification to the set of configuration parameters, subsequent to the outputting but prior to the saving; and
re-rendering the virtual representation to incorporate the modification to the set of configuration parameters.

15. The method of claim 13, wherein the virtual representation comprises a digital twin of the data center.

16. The method of claim 13, wherein the virtual representation comprises virtual representations of racks, hardware modules, and cables of the data center.

17. The method of claim 13, wherein the set of configuration parameters comprises at least one of: physical dimensions of the data center, a layout of the data center, a number of racks in the data center, a number of hardware modules in the data center, types of the hardware modules, locations of the hardware modules in the data center, a number of cables connecting the hardware modules, types of the cables, locations of the cables, or lengths of the cables.

18. The method of claim 13, wherein the set of configuration parameters is obtained as an input file that is imported from an external application.

19. The method of claim 13, wherein the set of configuration parameters is obtained as a set of actions performed by a user on a set of templates.

20. The method of claim 13, wherein the rendering comprises calculating a length of a cable of the data center.
